(19) United States
(12) Patent Application Publication
(10) Pub. No.: US 2004/0197366 A1
(43) Pub. Date: Oct. 7, 2004

(54) Stabilized insect bait formulation and method

(75) Inventors: Terrence R. Burke, Kirkwood, MO (US); Robin L. Kern, Fenton, MO (US); Brian Potts, Troy, IL (US); Ronald O. Richardson, Ellisville, MO (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Whitmire Micro-Gen Research Laboratories, Inc.

(21) Appl. No.: 10/395,952

(22) Filed: Mar. 24, 2003

(51) Int. Cl. A01N 25/00; A01N 25/08

(52) U.S. Cl. 424/410

(57) ABSTRACT

An aqueous sucrose-containing insect bait formulation may be stabilized against short term degradation or loss of sweetness by incorporating borax in the aqueous bait formulation. Stabilization against degradation or loss of sweetness at higher temperatures can be achieved by incorporating borax and an antimicrobial agent in the aqueous bait formulation. Preferably, borax is present in an amount ranging from approximately 0.1 to 10% by weight and an antimicrobial agent is present in an amount of approximately 0.2% by weight.

### BACKGROUND OF THE INVENTION

This invention relates to stabilized insect bait formulations and, more particularly, to insect bait formulations and methods for stabilizing sugar sweetness in formulations containing borates.

As is well known, insect baits utilizing boric acid and/or borate salts as a toxicant combined with sugar as the attractant have been marketed as safe insect control formulations for many years. Commercial evaluations and research studies involving these formulations have shown various inconsistencies from time to time with regard to insect attraction, ingestion and control. Many theories have been proposed to explain these inconsistencies. These include the following, for example: a) borates are repellent above a certain concentration; b) insects change food preferences from time to time and pass up sweet foods for protein foods; c) a blend of sugars is needed rather than a single sugar and blend preference changes with time; d) bait formulations have too much sugar and too little water as in drought times; and e) bait formulations have too little sugar to attract insects in times of abundant water.

While these explanations may in part account for the inconsistencies, we have discovered that an overriding cause of the inconsistencies is fundamentally related to bait formulation composition. In particular, we have discovered that the interaction or complexing of boron with sugars, alcohols, glycols and polyols results in a less attractive bait. It is well known that boron salts and boric acid readily complex with monosaccharides and most disaccharides to form boro-saccharide compounds. One example is fructo-borate as described in U.S. Pat. Nos. 5,985,842 and 6,080,425.

Various prior art patents disclose the use of boric acid and/or borate salts as a toxicant for insect control and with or without being combined with sugar as the attractant. U.S. Pat. No. 5,232,701 discloses pesticidal compositions containing boron oxide or metaboric acid and in which sugar may be incorporated as a water-soluble carrier. U.S. Pat. No. 5,564,222 teaches a composition for poisoning of insects constituted by a cellulose body impregnated with a borate salt such as disodium octaborate tetrahydrate or disodium tetraborate decahydrate. U.S. Pat. No. 5,928,634 discloses a liquid insect bait comprising sorbitol dissolved in water, an insect attractant such as sucrose and an insect control active ingredient or insecticide such as boric acid or sodium borate. U.S. Pat. No. 6,007,832 discloses compositions containing boric acid, sugar and other components as insecticidal bait compositions for cockroaches. U.S. Pat. No. 6,286,247 discloses a mulch for poisoning termites which includes wood chips and/or tree bark impregnated with a borate salt such as disodium octaborate tetrahydrate or disodium tetraborate decahydrate. U.S. Pat. No. 6,399,109 discloses a liquid insecticide including a combination of either sucrose octa-acetate or denatonium benzoate and a nonwhite pigment with a mixture of disodium octaborate tetrahydrate.

There remains a need, therefore, for an insect bait composition or formulation containing a sugar such as sucrose and a borate compound and which retains its sweetness to the taste for insects such as ants for an extended length of time.

### SUMMARY OF THE INVENTION

Among the several objects of the invention may be noted the provision of an improved insect bait formulation which is stabilized against short term or premature loss of sweetness or degradation, the provision of such a formulation which incorporates a combination of sucrose and borax; the provision of such a bait formulation which is also stabilized against degradation or loss of sweetness at higher temperatures; and the provision of methods for stabilizing an aqueous sucrose-containing bait formulation against degradation or loss of sweetness over long time periods and which are characterized by extended stability and attractiveness. Other objects and features will be in part apparent and in part pointed out hereinafter.

Briefly, the present invention is directed to an insect bait formulation stabilized against short term sweetness loss or degradation and comprising sucrose, borax and water. The invention is also directed to a bait formulation stabilized against loss or degradation of sweetness at higher temperatures and which comprises sucrose, borax, an antimicrobial agent and water. The invention is further directed to methods for stabilizing aqueous sucrose-containing insect bait formulations against short term degradation or loss of sweetness at room temperature or against long term degradation at higher temperatures such as 40° C.

### DESCRIPTION OF THE PREFERRED EMBODIMENTS

In accordance with the present invention, it has been discovered that mixing fructose with boric acid or borate salts (such as borax or sodium octaborate) in water solution results in a solution that is sour to the taste. The sour taste is also present when borate salts or boric acid are added to solutions of glucose, glycerol and sorbitol. In addition, disaccharide sugars such as maltose also complex with borates and result in a sour rather than a sweet taste. It has been found that this bait “souring” phenomenon has contributed to the inconsistencies discussed above with respect to insect attraction, ingestion and control.

In connection with the present invention, it has been discovered that sucrose is the only common sugar that remains sweet to the taste for an extended length of time when mixed in solution with borate salts or boric acid. With time or when subjected to elevated temperatures, it is well known that a water solution of sucrose will convert from a disaccharide to the monosaccharides dextrose and fructose. When sucrose conversion, also known as sucrose inversion, takes place in a solution containing borates, the sweet taste is replaced with the characteristic sour taste of fructo-borate and glucose borate.

In further accordance with the present invention, it has been found that when borax is used as the toxicant in liquid or aqueous sucrose bait formulations, the desired sweet taste remains for several months longer than when boric acid or sodium octaborate is used as the toxicant. While not being bound by any particular theory, it is believed that the higher pH of borax solutions results in less free available dissociated boric acid in the solution and the free boric acid is responsible for complexing with the sugar and subsequent loss in sweetness. It has been found that boric acid will complex with sucrose and form a “sour” bait formulation fairly rapidly. The time required for this to occur is related to such factors as temperature, formulation components, solution concentration and other variables. Some bait formulations containing boric acid and sucrose may remain sweet for six months before turning sour, while some become sour immediately. It is thought that free boric acid speeds up the inversion of sucrose to fructose and dextrose. Boric acid immediately complexes with the invert sugars, fructose and glucose, forming the stronger acids of fructo-borate and glucose borate complexes. These stronger acids then increase further the rate of complexing. To delay this complexing action, it is necessary to decrease the available boric acid or boric acid complexes. When borate salts such as sodium octaborate are dissolved in water, the salt dissociates into several ionic species which then reach a certain equilibrium, boric acid being one of these species. The higher the concentration of boric acid at equilibrium, the greater the chance of complexing with a sugar. Monosaccharides, glycols, polyols and most disaccharide sugars complex immediately. Sucrose generally takes longer, but does eventually complex with boric acid. Once this occurs, the rate of complexing then increases rapidly as previously indicated.

In accordance with the present invention, it has been discovered that when borax is incorporated into aqueous sucrose-containing bait formulations, the desired sweet taste may be prolonged for periods of a year or more at room temperatures. It has also been found that the sweetness in borax-sucrose combination bait formulations can be tracked or correlated with pH changes, i.e. if a formulation's pH shifts toward the acid side, the sweetness will be reduced and a sour taste will grow. Borax, being an excellent buffering agent and having less free boric acid present during solution dissociation than other boron sources, is much more stable with respect to pH change and thus complexes sugars at a slower rate. While not being bound to any particular theory, it is believed that borax doesn't complex with sucrose directly at all, but rather it is thought that the sucrose must first form into invert sugars (glucose and fructose) before the borax solution's free boric acid content can override the borax pH buffering effects. In accordance with the present invention, we have discovered that sucrose is the only common sugar that functions in this manner. Thus, for example, the disaccharide maltose complexes with borax much faster and results in an immediate sour taste.

While the combination of borax and sucrose greatly prolongs the sweet taste in aqueous-based insect bait formulations, storage at higher temperatures, such as 40° C. for example, tends to increase the rate of borate/sugar complexing. Under these higher temperature conditions, sucrose in the formulations began to form the invert sugars fructose and glucose. This formation was monitored by analyzing an aqueous sucrose/borax solution for sucrose, fructose and glucose content over time at room temperature and at 40° C. It was found that over time as the sucrose content of the solution decreases, the fructose and glucose content increases at a proportional rate and the pH of the formulation continued to decrease. While it was assumed that the sucrose was forming into invert sugars which began complexing with the free boric acid in solution, it was found that some samples of the same formulation converted to complexes at different temperatures which led to the conclusion that microbial or enzyme actions were responsible for converting sucrose to invert sugars which in turn formed complexes with free boric acid. In further accordance with the present invention, it was found that the incorporation of an antimicrobial agent in the borax/sucrose aqueous formulations of the invention stabilized the sucrose content, pH and the desired sweet taste throughout a period of at least one year and at elevated temperatures such as 40° C. Various antimicrobial agents known to those skilled in the art may be employed in the practice of the invention. An exemplary antimicrobial agent is that marketed by Dow Chemical Company under the trade designation Dowicil 75 Preservative. This product is 1-(3-chloroallyl)-3,5,7-triaza-1-azoniaadamantane chloride combined with a sodium bicarbonate stabilizer. Sodium bicarbonate can also be used as an antimicrobial agent.

In carrying out the practice of the invention, the insect bait formulations may be stabilized against short term sweetness loss or degradation at room temperature or long term sweetness loss or degradation at elevated temperatures by incorporating in an aqueous sucrose solution between approximately 0.1 and 10% by weight of borax, preferably amounts such as 1.3% or 5.4% by weight. The amount of antimicrobial agent incorporated in the termite bait formulations of the invention to stabilize such formulations against degradation or loss of sweetness at higher temperatures such as 40° C. may vary, 0.2% by weight being an illustrative amount.

As used herein, the term “higher temperatures” is intended to mean temperatures of 40° C. and above. Also, as employed herein, the phrase “short term” is intended to mean a period of 6 months to a year while the phrase “long term” or “longer term” is intended to mean a period of from one to 2 plus years.

The following examples illustrate the practice of the invention.

### EXAMPLE 1

The following formulation was prepared:

| Component | % by weight |
|---|---|
| Deionized water | 48.70 |
| White granular sugar (sucrose) | 50.00 |
| Borax | 1.30 |
| (sodium tetraborate decahydrate) | |
| | 100.00 |

The formulation was tested periodically for shelf life stability at a temperature of 40° C. by determining the amount of sucrose remaining in the formulation. The results were as follows:

| Interval | Analysis | | Mean | |
|---|---|---|---|---|
| Days | Date | Target | Result | % Initial |
| 0 | Apr. 28, 2000 | 50.00 | 49.2189 | |
| 97 | Aug. 03, 2000 | | 48.0501 | 97.63 |
| 132 | Sep. 07, 2000 | | 49.1530 | 99.87 |
| 159 | Oct. 04, 2000 | | 47.6055 | 96.72 |
| 195 | Nov. 09, 2000 | | 45.1719 | 91.78 |

Thus, the formulation remained substantially stable against sweetness loss for a period of over 6 months.

### EXAMPLE 2

The following formulation was prepared:

| Component | % by weight |
|---|---|
| Deionized water | 52.60 |
| White granular sugar (sucrose) | 40.00 |
| Borax | 5.40 |
| (sodium tetraborate decahydrate) | |
| Water Lock G 400 | 2.00 |
| (super absorbent | |
| polymer/thickening agent) | |
| | 100.00 |

The formulation was tested at a temperature of 40° C. as described in Example 1 with the following results:

| Interval | Analysis | | Mean | |
|---|---|---|---|---|
| Days | Date | Target | Result | % Initial |
| 0 | May 02, 2000 | 40.00 | 41.0233 | |
| 92 | Aug. 02, 2000 | | 42.1630 | 102.78 |
| 128 | Sep. 07, 2000 | | 41.1349 | 100.27 |
| 155 | Oct. 04, 2000 | | 41.6679 | 101.57 |
| 191 | Nov. 09, 2000 | | 42.7470 | 104.20 |

The formulation thus remained stable against sweetness loss for a period of over 6 months when tested at 40° C.

The formulation was also tested at room temperature as described in Example 1 with the following results:

| Interval | Analysis | | Mean | |
|---|---|---|---|---|
| Days | Date | Target | Result | % Initial |
| 0 | May 02, 2000 | 40.00 | 41.0233 | |
| 92 | Aug. 02, 2000 | | 40.3334 | 98.32 |
| 128 | Sep. 07, 2000 | | 41.6218 | 101.46 |
| 155 | Oct. 04, 2000 | | 41.6363 | 101.49 |
| 191 | Nov. 09, 2000 | | 41.9887 | 102.35 |

The formulation thus remained stable against sweetness loss for a period of over 6 months when tested at room temperature.

### EXAMPLE 3

The following formulation was prepared:

| Component | % by weight |
|---|---|
| Deionized water | 47.00 |
| White granular sugar (sucrose) | 47.60 |
| Borax | 5.40 |
| (sodium tetraborate decahydrate) | |
| | 100.00 |

The formulation was tested at a temperature of 40° C. as described in Example 1 with the following results:

| Interval | Analysis | | Mean | |
|---|---|---|---|---|
| Days | Date | Target | Result | % Initial |
| 0 | Apr. 28, 2000 | 47.60 | 47.9040 | |
| 96 | Aug. 02, 2000 | | 48.6105 | 101.47 |
| 132 | Sep. 07, 2000 | | 48.7650 | 101.80 |
| 159 | Oct. 04, 2000 | | 46.0054 | 96.04 |
| 195 | Nov. 09, 2000 | | 45.8265 | 95.66 |

The formulation thus remained stable against sweetness loss for a period of over 6 months when tested at a temperature 40° C.

The formulation was also tested at room temperature as described in Example 1 with the following results:

| Interval | Analysis | | Mean | |
|---|---|---|---|---|
| Days | Date | Target | Result | % Initial |
| 0 | Apr. 28, 2000 | 47.60 | 47.9040 | |
| 96 | Aug. 02, 2000 | | 46.7282 | 97.55 |
| 132 | Sep. 07, 2000 | | 47.7568 | 99.69 |
| 159 | Oct. 04, 2000 | | 50.8630 | 106.18 |
| 195 | Nov. 09, 2000 | | 42.3420 | 88.39 |

The formulation thus remained stable against sweetness loss for over 6 months when tested at room temperature.

### EXAMPLE 4

The following formulation was prepared:

| Component | % by weight |
|---|---|
| Deionized water | 52.60 |
| White granular sugar (sucrose) | 40.00 |
| Borax | 5.40 |
| (sodium tetraborate decahydrate) | |
| Water Lock G 400 | 2.00 |
| | 100.00 |

The formulation was tested over time at 40° C. to determine the amount of borax and sucrose remaining with the following results:

| | | | | |
|---|---|---|---|---|
| Interval | Analysis | | Mean | |
| Days | Date | Target | Result | % Initial |

Sodium tetraborate (Borax)

| | | | | |
|---|---|---|---|---|
| 0 | Jul. 18, 2000 | 5.40 | 5.6711 | |
| 99 | Oct. 25, 2000 | | 5.2967 | 93.40 |

Sucrose

| | | | | |
|---|---|---|---|---|
| 0 | Jul. 18, 2000 | 40.00 | 38.5979 | |
| 99 | Oct. 25, 2000 | | 43.8740 | 113.67 |

The formulation was thus stable against degradation or loss of sweetness after 99 days when tested at 40° C.

### EXAMPLE 5

The following formulation was prepared:

| Component | % by weight |
|---|---|
| Deionized water | 48.50 |
| Dowicil 75 preservative | 0.20 |
| White granular sugar (sucrose) | 50.00 |
| Borax | 1.30 |
| (sodium tetraborate decahydrate) | |
| | 100.00 |

The formulation was tested at room temperature for shelf life stability by determining the amount of borax and sucrose remaining after specified time periods. The results were as follows:

| | | | | |
|---|---|---|---|---|
| Interval | Analysis | | Mean | |
| Days | Date | Target | Result | % Initial |

Borax

| | | | | |
|---|---|---|---|---|
| 0 | Dec. 18, 2000 | 1.30 | 1.4333 | |
| 32 | Jan. 19, 2001 | | 1.3567 | 94.65 |
| 56 | Feb. 12, 2001 | | 1.4200 | 99.07 |
| 94 | Mar. 22, 2001 | | 1.4300 | 99.77 |

Sucrose

| | | | | |
|---|---|---|---|---|
| 0 | Dec. 18, 2001 | 50.00 | 46.0397 | |
| 32 | Jan. 19, 2001 | | 46.2538 | 100.47 |
| 56 | Feb. 12, 2001 | | 50.9251 | 110.61 |
| 94 | Mar. 22, 2001 | | 48.5484 | 105.45 |

The formulation was also tested at 40° C. with the following results:

| | | | | |
|---|---|---|---|---|
| Interval | Analysis | | Mean | |
| Days | Date | Target | Result | % Initial |

Borax

| | | | | |
|---|---|---|---|---|
| 0 | Dec. 18, 2000 | 1.30 | 1.4333 | |
| 32 | Jan. 19, 2001 | | 1.4333 | 100.00 |
| 53 | Feb. 09, 2001 | | 1.4400 | 100.47 |
| 94 | Mar. 22, 2001 | | 1.4167 | 98.84 |

Sucrose

| | | | | |
|---|---|---|---|---|
| 0 | Dec. 18, 2000 | 50.00 | 46.0397 | |
| 32 | Jan. 19, 2001 | | 49.6507 | 107.84 |
| 53 | Feb. 09, 2001 | | 50.5533 | 109.80 |
| 94 | Mar. 22, 2001 | | 49.6342 | 107.81 |

The formulation was thus stable against sweetness loss or degradation even at elevated temperature due to the incorporation of the antimicrobial agent Dowicil 75.

### EXAMPLE 6

The following formulations were prepared. The basic formula was as follows:

| Component | % by weight |
|---|---|
| Deionized water | 3720.00 g. |
| Sugar, white granular | 4000.00 g. |
| Borax | 104.00 g. |
| Variable mixture | 176.00 g. |
| Total concentrate | 8000.00 g. |

The variable mixtures to be added to the above are as follows:

| | |
|---|---|
| Formulation 6A: | None |
| Formulation 6B: | 0.20% Dowicil 75 |
| Formulation 6C: | 1.00% Krystar brand Fructose |
| Formulation 6D: | 1.00% Sodium bicarbonate |
| Formulation 7A: | 0.20% Dowicil 75 |
| | 1.00% Krystar brand Fuctose |
| Formulation 7B: | 0.20% Dowicil 75 |
| | 1.00% Krystar |
| | 1.00% Sodium bicarbonate |
| Formulation 7C: | 0.20% Dowicil 75 |
| | 1.00% Sodium bicarbonate |
| Formulation 7D: | 1.00% Krystar |
| | 1.00% Sodium bicarbonate |

All the variables were brought up to 2.2% by the addition of deionized water. In these experiments, a single 8000 gram base mixture as indicated above was prepared. From this base mixture, 8-1000 gram aliquots were removed. To each aliquot, one of the test variable mixtures listed above was added. Each aliquot was then subdivided and one was stored at room temperature and the other at 40° C. The pH was then monitored weekly for two months, then again at 3, 6, 9 and 12 months or until the pH dropped below 5.

The results are set forth in the following table.

| | 6A | | 6B | | 6C | | 6D | | 7A | | 7B | | 7C | | 7D | |
|---|---|---|---|---|---|---|---|---|---|---|---|---|---|---|---|---|
| Date | RT | 6A 40 | RT | 6B 40 | RT | 6C 40 | RT | 6D 40 | RT | 7A 40 | RT | 7B 40 | RT | 7C 40 | RT | 7C 40 |
| Oct. 30, 2000 | 7.43 | 7.43 | 7.45 | 7.45 | 6.99 | 6.99 | 7.51 | 7.51 | 7.00 | 7.00 | 7.29 | 7.29 | 7.51 | 7.51 | 7.24 | 7.24 |
| Oct. 31, 2000 | 7.42 | | 7.42 | | 6.92 | | 7.56 | | 6.93 | | 7.26 | | 7.49 | | 7.29 | |
| Nov. 06, 2000 | 7.41 | 7.53 @ | 7.42 | 7.51 @ | 6.93 | 6.97 @ | 7.59 | 7.66 @ | 6.93 | 7.08 @ | 7.36 | 7.45 @ | 7.53 | 7.59 @ | 7.42 | 7.53 @ |
| | | 35.3 | | 36.3 | | 35.2 | | 35.1 | | 33.4 | | 35.1 | | 33.8 | | 30.8 |
| Nov. 13, 2000 | 7.41 | 7.51 @ | 7.54 | 7.52 @ | 6.81 | 7.01 @ | 7.80 | 7.76 @ | 7.08 | 7.10 @ | 7.53 | 7.62 @ | 7.75 | 7.73 @ | 7.59 | 7.63 @ |
| | | 30.0 | | 30.8 | | 30.5 | | 31.6 | | 29.7 | | 30.0 | | 30.5 | | 29.9 |
| Nov. 20, 2000 | 7.29 | 7.50 | 7.46 | 7.46 | 6.43 | 6.99 | 7.72 | 7.74 | 7.03 | 7.01 | 7.53 | 7.59 | 7.65 | 7.71 | 7.60 | 7.60 |
| Nov. 27, 2000 | 7.00 | 7.49 | 7.48 | 7.47 | 5.98 | 6.96 | 7.83 | 7.80 | 7.04 | 7.04 | 7.60 | 7.63 | 7.72 | 7.74 | 7.62 | 7.67 |
| Dec. 04, 2000 | 6.36 | 7.49 | 7.52 | 7.51 | 5.56 | 6.95 | 7.82 | 7.90 | 7.09 | 7.01 | 7.70 | 7.73 | 7.84 | 7.86 | 7.78 | 7.80 |
| Dec. 11, 2000 | 5.78 | 7.40 | 7.45 | 7.42 | 5.18 | 6.94 | 7.68 | 7.88 | 7.01 | 6.94 | 7.68 | 7.72 | 7.78 | 7.79 | 7.69 | 7.74 |
| Dec. 18, 2000 | 5.34 | 7.43 | 7.45 | 7.41 | 4.96 | 6.88 | 7.67 | 7.93 | 7.03 | 6.94 | 7.75 | 7.72 | 7.92 | 7.83 | 7.77 | 7.76 |
| Jan. 04, 2001 | 4.85 | 7.40 | 7.43 | 7.41 | 4.52 | 6.84 | 7.51 | 7.92 | 7.02 | 6.90 | 7.77 | 7.76 | 7.92 | 7.88 | 7.57 | 7.80 |
| Jan. 22, 2001 | 4.35 | 7.36 | 7.39 | 7.36 | 4.20 | 6.76 | 7.32 | 7.92 | 7.00 | 6.84 | 7.73 | 7.76 | 7.89 | 7.89 | 7.17 | 7.80 |
| Feb. 08, 2001 | 4.11 | 7.35 | 7.45 | 7.36 | 4.02 | 6.74 | 7.35 | 8.00 | 7.00 | 6.80 | 7.82 | 7.79 | 8.00 | 7.97 | 7.06 | 7.82 |
| Mar. 14, 2001 | 3.74 | 7.34 | 7.43 | 7.36 | 3.76 | 6.67 | 7.41 | 8.16 | 7.04 | 6.72 | 7.92 | 7.83 | 8.07 | 8.05 | 7.20 | 7.87 |
| Jun. 12, 2001 | 3.33 | 6.99 | 7.38 | 7.11 | 3.20 | 6.24 | 7.59 | 8.00 | 6.96 | 6.35 | 7.93 | 7.71 | 8.06 | 8.01 | 7.44 | 7.75 |
| Oct. 02, 2001 | 3.23 | 6.57 | 7.35 | 6.80 | 3.26 | 5.67 | 7.00 | 7.90 | 6.96 | 5.77 | 7.93 | 7.62 | 8.07 | 7.96 | 7.43 | 7.69 |

In the above table, RT refers to “room temperature” and 40 refers to 40° C. The lower numbers appearing in the columns opposite Nov. 06, 2000 and Nov. 13, 2000 refers to temperatures in degrees centigrade.

In view of the above, it will be seen that the several objects of the invention are achieved and other advantageous results attained.

As various changes could be made in the above compositions and methods without departing from the scope of the invention, it is intended that all matter contained in the above description and shown in the accompanying drawings shall be interpreted as illustrative and not in a limiting sense.

What is claimed is:

1. An insect bait formulation stabilized against short term degradation or loss of sweetness comprising sucrose, borax and water.

2. An insect bait formulation as set forth in claim 1 containing between approximately 0.1 and 10% by weight of borax.

3. An insect bait formulation as set forth in claim 1 containing approximately 1.3% by weight of borax.

4. An insect bait formulation stabilized against degradation or loss of sweetness at higher temperatures comprising sucrose, borax, an antimicrobial agent and water.

5. An insect bait formulation as set forth in claim 4 containing between approximately 0.1 and 10% by weight of borax.

6. An insect bait formulation as set forth in claim 4 containing approximately 1.3% by weight of borax.

7. An insect bait formulation as set forth in claim 4 wherein said antimicrobial agent is 1-(3-chloroallyl)-3,5,7-triaza-1-azoniaadamantane chloride.

8. A method for stabilizing an aqueous sucrose-containing insect bait formulation against short term degradation or loss of sweetness which comprises incorporating borax in said aqueous bait formulation.

9. A method as set forth in claim 8 wherein borax is present in an amount ranging from approximately 0.1 to 10% by weight of said formulation.

10. A method as set forth in claim 8 wherein borax is present in an amount of approximately 1.3% by weight of said formulation.

11. A method for stabilizing an aqueous sucrose-containing insect bait formulation against degradation or loss of sweetness at higher temperatures which comprises incorporating borax and an antimicrobial agent in said aqueous bait formulation.

12. A method as set forth in claim 11 wherein said antimicrobial agent is 1-(3-chloroallyl )-3,5,7-triaza-1-azoniaadamantane chloride.

13. A method as set forth in claim 11 wherein borax is present in an amount ranging from approximately 0.1 to 10% by weight.

14. A method as set forth in claim 11 wherein said antimicrobial agent is present in an amount of approximately 0.2% by weight of said formulation.
